(19) United States
(12) Patent Application Publication
(10) Pub. No.: US 2024/0395426 A1
(43) Pub. Date: Nov. 28, 2024

(54) SUPPORTS WITH INTEGRATED SENSORS FOR NUCLEAR REACTOR STEAM GENERATORS, AND ASSOCIATED SYSTEMS AND METHODS

(71) Applicant: NuScale Power, LLC, Corvallis, OR (US)

(72) Inventor: Kent Welter, Corvallis, OR (US)

(21) Appl. No.: 18/766,171

(22) Filed: Jul. 8, 2024

Related U.S. Application Data
(62) Division of application No. 17/168,118, filed on Feb. 4, 2021, now Pat. No. 12,062,461.

(51) Int. Cl. G21C 17/112; B33Y 10/00; F22B 1/16; F28D 7/02; F28F 9/00; G21C 15/18; G21C 17/10

(52) U.S. Cl. CPC G21C 17/112; G21C 15/182; G21C 17/102; B33Y 10/00; F22B 1/162; F28D 7/02; F28F 9/00

(57) ABSTRACT

The disclosure is directed to a system and techniques for integrating sensors within a generator support to detect fluctuations. Such techniques may be performed by a device that includes at least one fiber optic sensor and may comprise receiving, via the at least one fiber optic sensor, an optical signal transmitted over at least one fiber optic link integrally formed with a conduit support, the conduit support coupled with a steam generator conduit. The techniques may further comprise generating, based on the optical signal, strain data related to the steam generator conduit, and based on the generated strain data, determine one or more oscillatory characteristic of a steam generator associated with the steam generator conduit.

### CROSS-REFERENCE TO RELATED APPLICATIONS

This application is a divisional application of U.S. patent application Ser. No. 17/168,118, filed on Feb. 4, 2021 and titled “SUPPORTS WITH INTEGRATED SENSORS FOR NUCLEAR REACTOR STEAM GENERATORS, AND ASSOCIATED SYSTEMS AND METHODS”, which is incorporated herein by reference in its entirety.

### STATEMENT REGARDING FEDERALLY SPONSORED RESEARCH

This invention was made with Government support under Contract No. DE-NE0008928 awarded by the Department of Energy. The Government has certain rights in this invention.

### TECHNICAL FIELD

The present technology is directed generally to supports with integrated sensors for nuclear reactor steam generators, and associated systems and methods.

### BACKGROUND

Nuclear power plants have been used for many years to generate steam, which is then converted to electrical power via a steam turbine. Large power plants can be used to provide electricity to corresponding large geographical areas, while relatively small power plants can be used to power smaller geographical areas, submarines, spacecraft, and/or other power-demanding systems and subsystems. In addition to providing electricity, nuclear reactors can be used for one or more other purposes, including, but not limited to desalinating seawater and creating nuclear isotopes for medical purposes.

Nuclear reactors typically include a significant amount of instrumentation to monitor system conditions and respond, as needed, by changing the parameters in accordance with which the reactors operate. While existing sensor systems have been adequate, there remains a need for improving the accuracy and manufacturability of such sensors in a manner that does not significantly increase the complexity and/or cost of the overall system.

### BRIEF DESCRIPTION OF THE DRAWINGS

Many aspects of the present technology can be better understood with reference to the following drawings. The components in the drawings are not necessarily to scale. Instead, emphasis is placed on clearly illustrating the principles of the present technology.

FIG. 1 is a partially schematic, cross-sectional illustration of a representative system configured in accordance with embodiments of the present technology.

FIG. 2A is a partially schematic illustration of a portion of a steam generator that includes conduit supports configured in accordance with embodiments of the present technology.

FIG. 2B is an enlarged illustration of conduit supports and associated conduits, arranged in accordance with embodiments of the present technology.

FIG. 2C is a partially schematic illustration of an arrangement of rails for aligning and supporting multiple conduit supports, in accordance with embodiments of the present technology.

FIG. 3 is a partially schematic, isometric illustration of a conduit support having one or more sensors integrally manufactured via additive manufacturing techniques, in accordance with embodiments of the present technology.

FIG. 4 is a partially schematic illustration of a representative sensor suitable for being integrally formed with a conduit support in accordance with embodiments of the present technology.

### DETAILED DESCRIPTION

Aspects of the present technology are directed generally toward supports having integrated sensors for operation in nuclear reactor steam generators. In particular embodiments, the supports carry a helical arrangement of steam generator conduits, which receive heat from a nuclear reactor core and generate steam which is then used to generate electrical power. The supports can include integrally formed sensors, which can accurately identify parameters associated with the operation of the steam generator, in a manner that provides for increased robustness and/or reliability. For example, the sensors can include additively manufactured optical strain gauges that are formed directly in the supports that keep the conduits in position within the nuclear reactor. By integrally forming the sensors with the supports, the sensors can more accurately identify changes in the characteristics, e.g., vibrations or oscillations, of the supports (and the associated conduits), and can be protected by virtue of being buried within the supports.

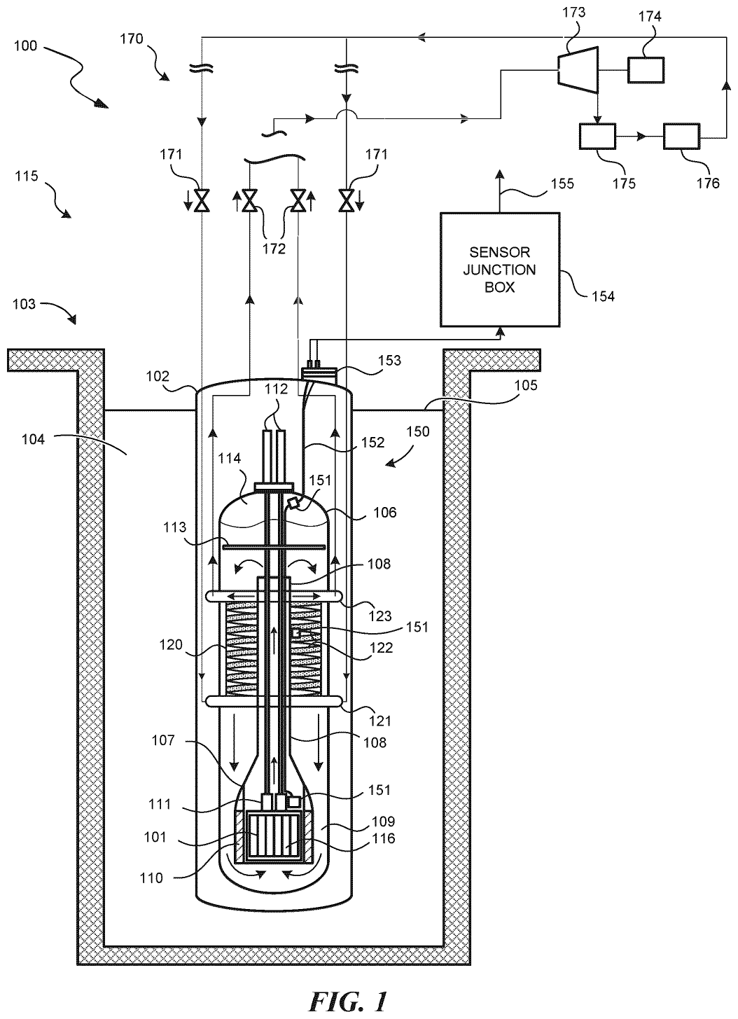

Certain details are set forth in the following description and in FIGS. 1-4 to provide a thorough understanding of various embodiments of the present technology. In other instances, well-known structures, materials, operations, and/or systems often associated with nuclear reactors, steam generators, and/or sensors are not shown or described in detail in the following disclosure to avoid unnecessarily obscuring the description of the various embodiments of the technology. Those of ordinary skill in the relevant art will recognize, however, that the present technology can be practiced without one or more of the details set forth herein, and/or with other structures, methods, components, and so forth.

The terminology used below is to be interpreted in its broadest reasonable manner, even though it is being used in conjunction with a detailed description of certain examples of embodiments of the technology. For example, certain terms may even be emphasized below; however, any terminology intended to be interpreted in any restricted manner will be overtly and specifically defined as such in this Detailed Description section.

The accompanying Figures depict embodiments of the present technology and are not intended to be limiting of its scope unless expressly indicated. The sizes of various depicted elements are not necessarily drawn to scale, and these various elements may be enlarged to improve legibility. Component details may be abstracted in the Figures to exclude details, such as the positions of components and/or certain precise connections between such components, when such details are unnecessary for a complete understanding of how to make and use the present technology. Many of the details, dimensions, angles and other features shown in the Figures are merely illustrative of particular embodiments of the disclosure. Accordingly, other embodiments can have other suitable details, dimensions, angles and features without departing from the present technology. In addition, those of ordinary skill in the art will appreciate that further embodiments of the present technology can be practiced without several of the details described below.

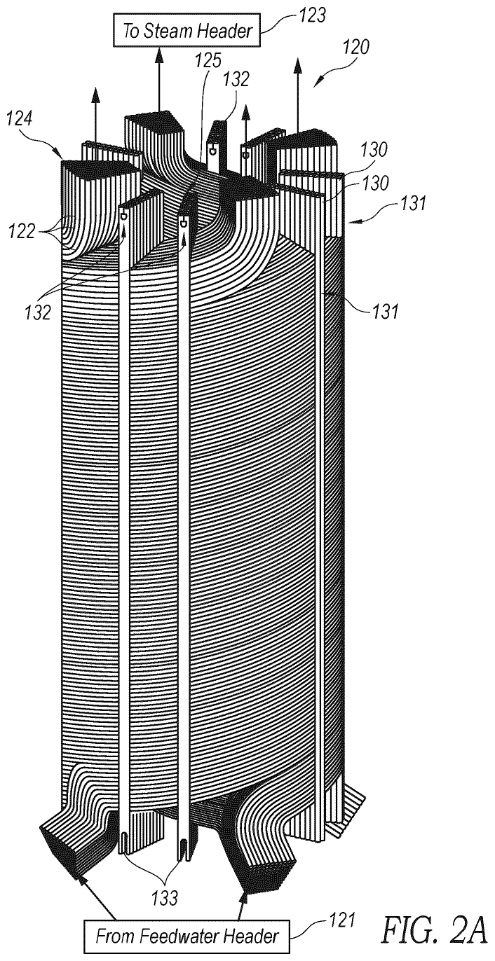

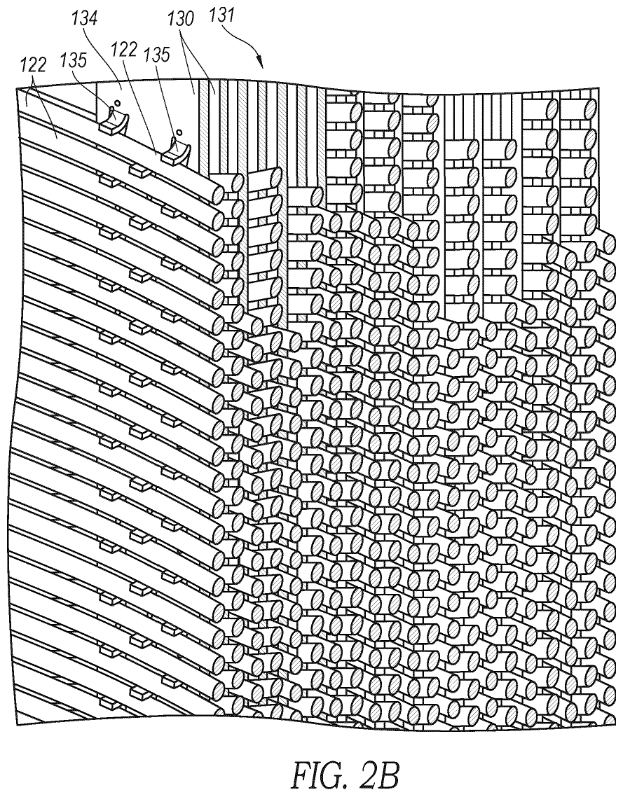

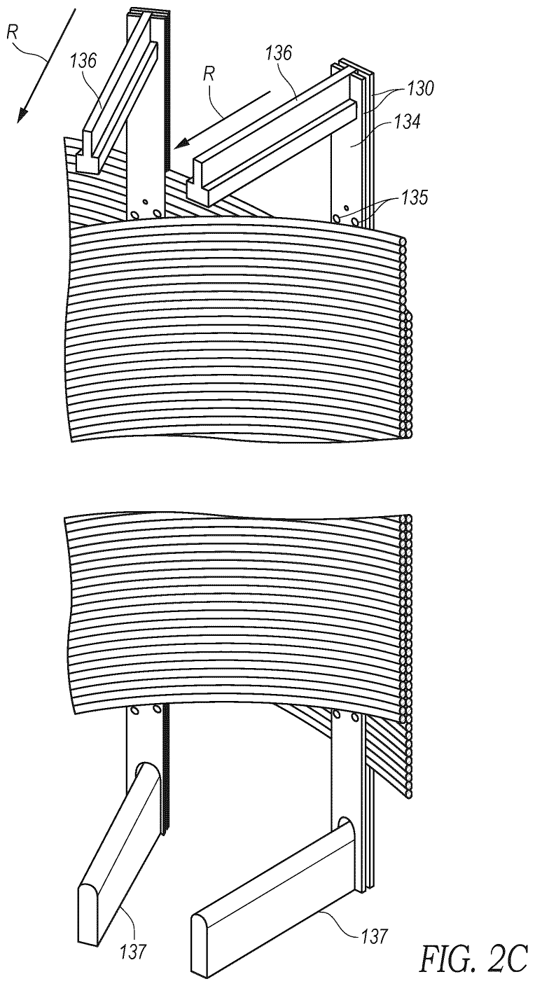

The overall arrangement of a representative system is described below with reference to FIG. 1. Specific elements of the steam generator and associated sensors are then described in further detail below with reference to FIGS. 2A-4.

FIG. 1 is a partially schematic, partial cross-sectional illustration of a nuclear reactor system 100. The system 100 can include a power module 115 having a reactor core 101 in which a controlled nuclear reaction takes place. Accordingly, the reactor core 101 can include one or more fuel assemblies 116. The fuel assemblies 116 can include fissile and/or other suitable materials. Heat from the reaction generates steam at a steam generator 120, which directs the steam to a power conversion system 170. The power conversion system 170 generates electrical power, and/or provides other useful outputs. A sensor system 150 is used to monitor the operation of the power module 115 and/or other system components. The data obtained from the sensor system 150 can be used in real time to control the power module 115, and/or can be used to update the design of the power module 115 and/or other system components.

The power module 115 includes a containment vessel 102 that houses/encloses a reactor pressure vessel 106, which in turn houses the reactor core 101. The containment vessel 102 can be housed in a power module bay 103. The power module bay 103 can contain a cooling pool 104 filled with water and/or another suitable cooling liquid. The bulk of the power module 115 can be positioned below the surface 105 of the cooling pool 104. Accordingly, the cooling pool 104 can operate as a thermal sink, e.g., in the event of a system malfunction.

A volume between the reactor pressure vessel 106 and the containment vessel 102 can be partially or completely evacuated to reduce heat transfer from the reactor pressure vessel 106 to the surrounding environment (e.g., to the cooling pool 104). However, in other embodiments the volume between the reactor pressure vessel 106 and the containment vessel 102 can be at least partially filled with a gas and/or a liquid that increases heat transfer between the reactor pressure vessel 106 and the containment vessel 102.

Within the reactor pressure vessel 106, a primary coolant 109 conveys heat from the reactor core 101 to the steam generator 120. For example, as illustrated by arrows located within the pressure vessel 106, the primary coolant 109 is heated at the reactor core 101 toward the bottom of the reactor pressure vessel 106. The heated primary coolant (e.g., water with or without additives) rises from the reactor core 101 through a core shroud 107 and to a riser tube 108. The hot, buoyant primary coolant 109 continues to rise through the riser tube 108, then exits the riser tube 108 and passes downwardly through the steam generator 120. The steam generator 120 includes a multitude of conduits 122 that are arranged circumferentially around the riser tube 108, for example, in a helical pattern, as is shown schematically in FIG. 1. The descending primary coolant 109 transfers heat to a secondary coolant (e.g., water) within the conduits 122, and descends to the bottom of the reactor pressure vessel 106 where the cycle begins again. The cycle can be driven by the changes in the buoyancy of the primary coolant 109, thus reducing or eliminating the need for pumps to move the primary coolant 109.

The steam generator 120 includes a feedwater header 121 by which the incoming secondary coolant enters the steam generator conduits 122. The secondary coolant rises through the conduits 122, converts to vapor (e.g., steam), and is collected at a steam header 123. The steam exits the steam header 123 and is directed to the power conversion system 170.

The power conversion system 170 can include one or more steam valves 172 that regulate the passage of high pressure, high temperature steam from the steam generator 120 to a steam turbine 173. The steam turbine 173 converts the thermal energy of the steam to electricity via a generator 174. The low pressure steam exiting the turbine 173 is condensed at a condenser 175, and then directed (e.g., via a pump 176) to one or more feedwater valves 171. The feedwater valves 171 control the rate at which the feedwater re-enters the steam generator 120 via the feedwater header 121.

The power module 115 includes multiple control systems and associated sensors. For example, the power module 115 can include a hollow cylindrical reflector 110 that directs neutrons back into the reactor core 101 to further the nuclear reaction taking place therein. Control rods 111 are used to modulate the nuclear reaction, and are driven via fuel rod drivers 112. The pressure within the reactor pressure vessel 106 can be controlled via a pressurizer plate 113 (which can also serve to direct the primary coolant 109 downwardly through the steam generator 120) by controlling the pressure in a pressurizing volume 114 positioned above the pressurizer plate 113.

The sensor system 150 can include one or more sensors 151 positioned at a variety of locations within the power module 115 and/or elsewhere, e.g., to identify operating parameter values and/or changes in parameter values, etc. The data collected by the sensor system 150 can then be used to control the operation of the system 100, and/or to generate design changes for the system 100. For some sensors positioned within the containment vessel 102, a sensor link 152 directs data from the sensors to a flange 153 (at which the sensor link 152 exits the containment vessel 102) and directs data to a sensor junction box 154. From there, the sensor data can be routed to one or more controllers and/or other data systems via a data bus 155.

One challenge associated with nuclear reactors and, in particular, steam generators within the reactors, is that the process of converting water to steam may not occur uniformly or smoothly within the steam generator. In particular, density waves can form within the conduits of the steam generator, creating density wave oscillations, which produce vibrations and stresses on the conduits and/or other elements of the steam generator. As described in further detail below with reference to FIGS. 2A-4, aspects of the present technology are directed to improved sensors and associated techniques for detecting characteristics of the steam generator, including strains produced by density wave oscillations.

FIG. 2A is a partially schematic, isometric illustration of a representative steam generator 120 having a multitude of conduits 122 arranged around a central opening 125. The central opening 125 accommodates the riser tube 108, described above with reference to FIG. 1. The conduits 122 can be arranged in one or more conduit bundles 124 that circle the central opening 125 in a helical fashion to provide extensive thermal and fluid contact between the outer walls of the conduits 122 and the surrounding primary coolant. Water enters the conduits 122 from the feedwater header 121 and exits via the steam header 123. The conduits 122 can be supported via multiple conduit supports 130. Individual conduit supports 130 can be arranged in conduit support stacks 131 that extend radially outwardly from the central opening 125. Each conduit support 130 can include an upper support rail aperture 132 and a lower support rail aperture 133 so as to be aligned along corresponding rails, described later with reference to FIG. 2C. In the illustrated embodiment, four conduits 122 are shown; it is understood that the above is merely one illustrative example to which the disclosed subject matter is not limited.

FIG. 2B is an enlarged illustration of a portion of a representative conduit support stack 131, illustrating multiple conduit supports 130 and corresponding conduits 122. Each conduit support 130 can include a carrier portion 134 and one or more retainer portions 135. For example, as shown in FIG. 2B, the retainer portions 135 can include projections that extend under and/or over each conduit 122 to support the conduits 122 in position. Generally, the conduits 122 are not rigidly attached to the retainer portions 135 to accommodate dimensional changes, e.g., due to thermal expansion. As shown in FIG. 2B, the conduit support stack 131 includes multiple, spaced-apart conduit supports 130, with “layers” of conduits 122 supported between neighboring pairs of conduit supports 130.

FIG. 2C illustrates the upper support rails 136 and lower support rails 137 positioned to align corresponding conduit supports 130. For purposes of illustration, two pairs of conduit supports 130 are shown aligned with corresponding pairs of upper and lower support rails 136, 137. Multiple additional conduit supports 130 can then be aligned along the rails 136, 137 in a radial direction R, as is shown in FIGS. 2A and 2B.

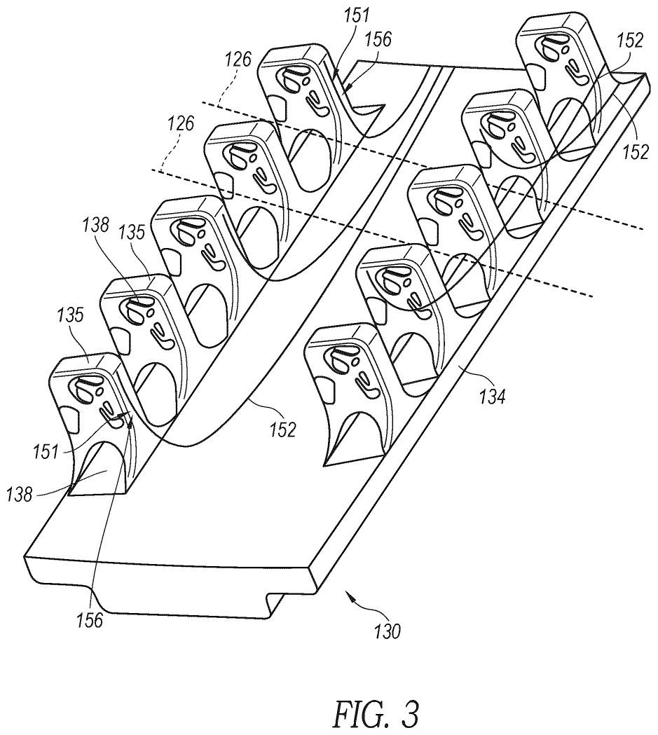

FIG. 3 is a partially schematic, isometric illustration of a representative conduit support 130 configured in accordance with embodiments of the present technology. The conduit support 130 can include a carrier portion 134, multiple retainer portions 135, and one or more sensors 151, all of which are integrally formed as a single unit. Accordingly, the conduit support 130 may be referred to herein as an instrumented support, or an instrumented conduit support. For example, the sensor 151, retainer portion 135, and carrier portion 134 can be integrally formed via an additive manufacturing technique. Suitable techniques include using a laser powder bed, or a direct energy deposition 3-D printer. However, such techniques may be limited to applications for which the embedded sensors 151 can withstand the high temperatures typically associated with such 3-D printing techniques. For sensors that cannot withstand such temperatures, ultrasonic additive manufacturing (UAM) techniques can be used instead. For example, UAM techniques can be used to additively manufacture structures that include both metals and non-metal constituents, without melting either. This in turn can allow dissimilar metals to be bonded, and can facilitate adding cladding materials, metal matrix composites, and/or “smart” or reactive structures. As a result, the sensor electronics can be embedded (below the outer surface of the supporting structure) in a tamper-resistant and/or tamper-proof, protective structure (e.g., the structure of the conduit support 130). Put another way, the sensors can be fully or at least partially encapsulated/enclosed within the structure they are co-manufactured with, in a nondestructive manner, and are accordingly protected from the harsh environment within the steam generator. In addition, the structure can include complex internal geometries, which can be readily manufactured via additive manufacturing techniques, but which may be difficult and/or impractical to manufacture using conventional subtractive techniques. For example, the conduit supports 130 can include openings 138 that reduce the quantity of material used to form the supports, and/or reduce heat transfer away from the steam within the conduits. Still further, the need for post-manufacture treatments (e.g., machining) can be reduced or eliminated, as a result of the fidelity of the additive manufacturing process.

In a representative embodiment shown in FIG. 3, the sensors 151 include fiber optic strain gauges 156 and associated communication links 152 that may also include fiber optic elements. In one such embodiment, the strain gauges 156 are integrally formed with the retainer portions 135, they can accurately register changes in strain imposed on the retainer portions 135 by the conduits carried by the retainer portions 135. The conduits (shown in FIGS. 2A-2C) extend along corresponding conduit axes 126 from one conduit support 130 to the next. In various embodiments, the strain gauges 156 are integrally formed with the retainer portions 135, allowing the material of the retainer portions 135 can help shield the strain gauges, e.g., from gamma radiation emitted by the reactor core. Such radiation can discolor the optics of the strain gauge 156 and/or the communication links 152 and accordingly, reduce or eliminate the sensor operability. By embedding the optic strain gauges 156, e.g., in a metal material, the likelihood for such degradation can be reduced, deferred, and/or eliminated, thus improving the ability to measure strain characteristics in the steam generator. For example, as shown in FIG. 3, the strain gauges 156 can be integrated with the retainer portions 135, and the communication links 152 can be integrated with the carrier portions 134, as well as with the retainer portions 135. The material forming the conduit support (e.g., the carrier portions 134 and/or the retainer portions 135) can include stainless steel in some embodiments, and other suitable materials in other embodiments.

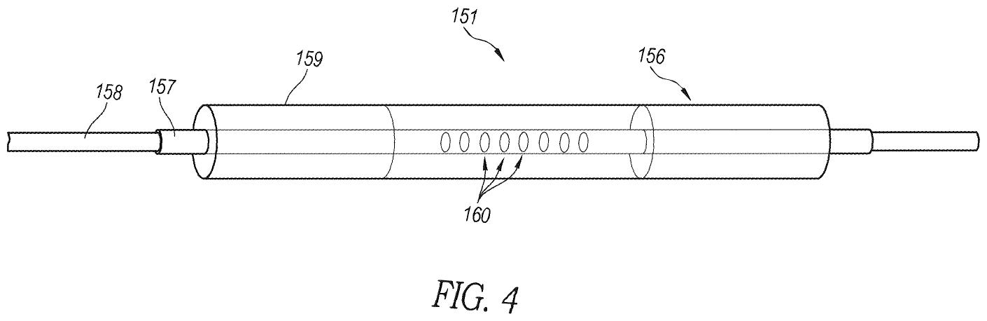

FIG. 4 illustrates a representative fiber optic strain gauge 156 having a generally conventional construction, but formed using a UAM technique integrally with a corresponding support. One possible representative device for performing such a technique includes a SonicLayer® 7200 automated system, available from Aniwaa (www.aniwaa.com). It is understood that the above is merely one illustrative example to which the disclosed subject matter is not limited. The UAM system can form a silica core 157 which transmits a light beam 158 and is surrounded by a cladding 159 for protection and to prevent light from escaping the core 157. The core 157 can include multiple Bragg grading elements 160 that refract and/or reflect light in different manners depending upon whether the strain gauge 156 is under strain and, if under strain, the value of the strain. The UAM process can also include forming the communication link 152 (FIG. 3) concurrently with the strain gauge 156 and the surrounding conduit support 130. Multiple communication links 152 can be routed through the corresponding conduit supports to a suitable junction box or other connection structure. Data collected by the sensors can then be routed out of the nuclear reactor via the flange 153 described above with reference to FIG. 1. Notably, at least one material forming the strain gauge 156 and/or other type(s) of sensor(s), is different than at least one material forming the conduit support 130, and the additive manufacturing process is selected to perform successfully despite that disparity.

The data obtained from the sensors can be used for one or more purposes tied to increasing reactor efficiency and/or providing other benefits for the corresponding nuclear reactor. For example, in operation, the sensors can more accurately detect the strains that may correspond to density wave oscillations and/or other flow phenomena, so that the operator can adjust the system operational parameters to avoid generating such phenomena. In another application, the data can be used to design or re-design elements of the reactor to reduce the likelihood for density wave oscillations and/or other flow phenomena to occur. Or, in another representative embodiment, elements can be designed or re-designed to produce a target oscillation frequency value and/or amplitude value, e.g., a target value that is acceptable for reactor operations.

For purposes of illustration, the representative sensor shown in FIGS. 3 and 4 is an optical strain sensor. In other embodiments, the sensor can have other constructions and/or can be used to measure other parameter values. For example, the sensor can include a thermal sensor (e.g., a thermocouple) configured to measure local temperatures within the steam generator or other system components in which the sensor is positioned. The data obtained from the thermal sensors, in conjunction with data obtained from strain sensors, can be used to further quantify and/or understand the characteristics of density wave oscillations and/or other flow phenomena. In other embodiments, the thermal sensors (and/or other sensors) can be used independently to assess any of a variety of suitable flow parameters, thermal parameters, and/or structural parameters.

In any of the foregoing embodiments, the ability to additively manufacture the sensors concurrently with the structures in which they are placed, can be used to efficiently produce an array (e.g., a three-dimensional array) of sensors that can more accurately capture phenomena in a multi-dimensional environment than can a small, scattered set of sensors. This ability can further improve the accuracy of the data and the efficacy of the steps taken based on that data.

The data collected by the sensors described above can be generally static, and/or dynamic, depending upon the application. For example, density wave oscillations generally have a frequency of about 0.1 Hz-0.3 Hz in the boiling region within the steam generator conduits 122. Accordingly, the strain sensors can be configured to measure changes in strain at frequencies high enough to capture the foregoing periodicity.

In addition to the applications described above (e.g., improved steam generator reliability for future designs, and/or providing an early indication or prediction of steam generator conduit fatigue), the foregoing data can be used for other purposes, e.g., to narrow or focus the inspections of the steam generator and/or other elements of the reactor to areas that are most likely to require such inspections. This in turn can reduce the need for, and cost associated with, inspecting structures that may not require it. In another application, thermal data obtained from an array or network of thermal sensors can be used to more accurately predict heat transfer characteristics within the steam generator, which in turn can influence steam generator design and result in more efficient, robust, and/or inexpensive steam generators.

From the foregoing, it will be appreciated that specific embodiments of the disclosed technology have been described herein for purposes of illustration, but that various modifications may be made without deviating from the technology. For example, the sensors can detect parameters other than strain and/or temperature. The sensors can be non-optical sensors, and/or can communicate data via non-optical communication links. While representative embodiments illustrate sensors positioned in steam generator conduit supports, sensors in accordance with other embodiments can be positioned in other system elements. Sensors positioned in the steam generator can be incorporated into the retainer portions of the conduit supports, and/or other portions of the conduit supports, e.g., the carrier portions.

Certain aspects of the technology described in the context of particular embodiments may be combined or eliminated in other embodiments. Further, while advantages associated with certain embodiments of the disclosed technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

As used herein, the phrase “and/or,” as in “A and/or B,” refers to A alone, B alone, and both A and B.

Representative examples of the present technology are provided below.

### Examples

1. A method for forming a nuclear-powered steam generator, comprising:
forming an instrumented support, the instrumented support including a carrier portion and retainer portion, wherein forming the instrumented support includes:
   integrally forming and embedding:
      (a) a fiber optic strain sensor with the conduit support, and
      (b) a fiber optic link with the carrier portion,
   via an additive manufacturing process;
supporting a helical steam conduit on the instrumented support; and
installing the helical steam conduit and the instrumented support in a nuclear reactor, along a primary flow path positioned to circulate a heated primary flow in thermal communication with the helical steam conduit.

2. The method of example 1 wherein the sensor includes at least one material that is not included in the conduit support.

3. The method of any of examples 1-2 wherein the instrumented support is formed from stainless steel.

4. The method of any of examples 1-3 wherein the instrumented support is one of a plurality of instrumented supports carrying the helical steam conduit.

5. The method any of examples 1-4 wherein the additive manufacturing process includes an ultrasonic additive manufacturing process.

6. A method for forming a nuclear-powered steam generator, comprising:
forming an instrumented support, the instrumented support including a carrier portion and retainer portion, at least one of the conduit support portion or the retainer portion being integrally formed with a sensor via an additive manufacturing process;
coupling the sensor to a communication link;
supporting a helical steam conduit on the instrumented support; and installing the helical steam conduit and the instrumented support in a nuclear reactor, along a primary flow path positioned to circulate a heated primary flow in thermal communication with the helical steam conduit.

7. The method of example 6 wherein the communication link includes an optical link.

8. The method of example 7, further comprising forming at least part of the optical link to be within an outer surface of the at least one of the carrier portion or the retainer portion.

9. The method of any of examples 6-8 wherein the sensor is formed to be within an outer surface of the at least one of the conduit support portion or the carrier portion.

10. The method of any of examples 6-9 wherein the sensor includes a strain sensor.

11. The method any of examples 6-9 wherein the sensor includes a thermal sensor.

12. The method of any of examples 6-11 wherein the additive manufacturing process incudes an ultrasonic additive manufacturing process.

13. The method of any of examples 6-12 wherein the process of forming the instrumented support includes forming the sensor within an outer surface of the at least one of the retainer portion or the carrier portion.

14. A method for sensing characteristics of a nuclear reactor, comprising:
receiving at least one of:
   (a) thermal data or
   (b) strain data
   from a sensor integrally formed with a support, the support carrying a helical steam generator conduit in a nuclear reactor;
based on the received data, evaluating a oscillatory characteristic of the helical steam generator.

15. The method of example 14, further comprising changing an operating characteristic of the nuclear reactor, based at least in part on the received data.

16. The method of example 14, further comprising changing a design of the helical steam generator, based at least in part on the received data.

17. The method of any of examples 14-16 wherein the oscillatory characteristic is a frequency of an oscillatory motion undergone by the helical steam generator.

18. The method of any of examples 14-17 wherein the oscillatory characteristic is an amplitude of an oscillatory motion undergone by the helical steam generator.

19. A nuclear reactor, comprising:
a pressure vessel;
a core positioned in the pressure vessel and configured to carry a fissile material;
a containment vessel positioned around the pressure vessel;
a riser tube in fluid communication with the core and positioned to direct a primary fluid flow along a primary flow path upwardly from the core, the primary flow path also passing downwardly in an annulus between the riser tube and the pressure vessel to circulate the primary fluid flow; and
a steam generator positioned in the annulus, the steam generator including an instrumented support, the instrumented support including:
   a carrier portion;
   a plurality of retainer portions carried by the carrier portion, wherein:
      (a) the carrier portion is integrally formed with a sensor via an additive manufacturing process; or
      (b) at least one of the retainer portions is integrally formed with a sensor via an additive manufacturing process; or
      (c) both (a) and (b); and
   a helical steam conduit carried by the plurality of instrumented supports.

20. The system of example 19 wherein the sensor is embedded within the carrier portion and/or at least one of the plurality of retainer portions.

21. The system of any of examples 19-20 wherein the sensor includes an optical sensor, and wherein the system further comprises an optical communication link coupled to the optical sensor and positioned within the carrier portion and/or at least one of the plurality of retainer portions.

I/We claim:

1. An electronic device, comprising:
at least one fiber optic sensor;
one or more processors; and
one or more non-transitory computer-readable media storing computer-executable instructions that, when executed by the one or more processors, cause the electronic device to:
receive, via the at least one fiber optic sensor, an optical signal transmitted over at least one fiber optic link integrally formed with a conduit support, the conduit support coupled with a steam generator conduit;
generate, based on the optical signal, strain data related to the steam generator conduit; and
based on the generated strain data, determine one or more oscillatory characteristic of a steam generator associated with the steam generator conduit.

2. The electronic device of claim 1, wherein the steam generator conduit is positioned along a primary flow path for the steam generator.

3. The electronic device of claim 1, wherein the steam generator conduit has a helical shape.

4. The electronic device of claim 1, wherein the strain data is generated based on optical signals received from multiple fiber optic sensors.

5. The electronic device of claim 1, wherein the steam generator conduit is configured to convey a secondary coolant around the steam generator.

6. The electronic device of claim 1, wherein the at least one fiber optic link is shielded by a retainer portion of the steam generator conduit.

7. The electronic device of claim 1, wherein the conduit support is one of multiple conduit supports that are arranged circumferentially around a portion of a steam generator.

8. A method for sensing characteristics of a steam generator, comprising:
receiving, at a fiber optic sensor, an optical signal transmitted over a fiber optic link integrally formed with a conduit support, the conduit support coupled with a steam generator conduit;
generating, based on the optical signal, strain data related to the steam generator conduit; and
based on the generated strain data, determining one or more oscillatory characteristic of a steam generator associated with the steam generator conduit.

9. The method of claim 8, further comprising causing at least one operating characteristic of the steam generator to be altered based at least in part on the generated strain data.

10. The method of claim 9, wherein causing at least one operating characteristic of the steam generator to be altered comprises adjusting one or more settings associated with the steam generator.

11. The method of claim 8, wherein the one or more oscillatory characteristic comprises a frequency of an oscillatory motion undergone by the steam generator.

12. The method of claim 8, wherein the one or more oscillatory characteristic comprises an amplitude of an oscillatory motion undergone by the steam generator.

13. The method of claim 8, wherein the steam generator is installed within a nuclear reactor.

14. The method of claim 8, further comprising causing a design associated with the steam generator to be updated based at least in part on the generated strain data.

15. The method of claim 8, wherein the steam generator conduit is configured to convey heat from a primary coolant outside of the steam generator conduit to a secondary coolant inside of the steam generator conduit.

16. The method of claim 15, further comprising determining one or more heat transfer characteristics based on the generated strain data.

17. A strain sensor system comprising:
a set of optic sensors;
a set of fiber optic links corresponding to the set of fiber optic sensors, individual fiber optic links of the set of fiber optic links integrally formed with one of multiple conduit supports for a steam generator; and
a device configured to
receive, from the set of optic sensors, a set of optical signals transmitted over the set of fiber optic links;
generate, based on the optical signals, strain data associated with the steam generator; and
based on the generated strain data, determine one or more oscillatory characteristic of the steam generator.

18. The strain sensor system of claim 17, wherein the multiple conduit supports form a helical pattern.

19. The strain sensor system of claim 18, wherein the helical pattern is formed circumferentially around a riser tube of a nuclear reactor.

20. The strain sensor system of claim 17, wherein the one or more oscillatory characteristic of the steam generator comprise at least one of a frequency or an amplitude of an oscillatory motion undergone by the steam generator.
